(19) United States
(12) Patent Application Publication
(10) Pub. No.: US 2009/0131616 A1
(43) Pub. Date: May 21, 2009

(54) Methods for Improving Heat Transfer in Polymerization Processes

(75) Inventors: David Knoeppel, League City, TX (US); Steve Nitz, Houston, TX (US); Steven Gray, Florence, KY (US)

Correspondence Address: FINA TECHNOLOGY INC, PO BOX 674412, HOUSTON, TX, 77267-4412, US

(73) Assignee: Fina Technology, Inc., Houston, TX (US)

(21) Appl. No.: 12/260,154

(22) Filed: Oct. 29, 2008

Related U.S. Application Data
(60) Provisional application No. 61/001,433, filed on Nov. 1, 2007.

(51) Int. Cl. C08F 4/08

(52) U.S. Cl. 526/237

(57) ABSTRACT

Methods for improving heat transfer in polymerization processes are described herein. The methods generally include contacting olefin monomer with a catalyst system within a reaction zone to form particles having a first average particle size and altering the reaction zone to improve heat transfer and form polymer particles having a second average particle size. For example, the second average particle size may be larger than the first average particle size and the second particle size results in improved heat transfer over the first particle size.

### CROSS-REFERENCE TO RELATED APPLICATIONS

This application claims the benefit of U.S. Provisional Patent Application Ser. No. 61/001,433, filed Nov. 1, 2007.

### FIELD

Embodiments of the present invention generally relate to polymerization processes. In particular, embodiments of the invention generally relate to heat transfer in polymerization processes.

### BACKGROUND

As reflected in the patent literature, polymerization processes may experience a significant reduction in reactor heat transfer. In some cases, this loss was believed to be a result of coating of the inner reactor walls. Therefore, attempts to improve heat transfer included employing anti-fouling agents. However, such attempts were met with mixed results when poor heat removal was not due to fouling on the reactor surface.

Therefore, a need exists to improve heat transfer within polymerization processes.

### SUMMARY

Embodiments of the present invention include methods for improving heat transfer in olefin polymerization processes. The methods generally include contacting olefin monomer with a catalyst system within a reaction zone to form particles having a first average particle size and altering the reaction zone to improve heat transfer and form polymer particles having a second average particle size. Embodiments of the invention generally result in a process wherein the second average particle size is larger than the first average particle size and the second particle size results in improved heat transfer over the first particle size.

### BRIEF DESCRIPTION OF DRAWINGS

FIG. 1 illustrates polymerization reactor jacket temperatures as a function of time.

FIG. 2 illustrates polymer wax levels as a result of reactor pressure.

### DETAILED DESCRIPTION

### Introduction and Definitions

A detailed description will now be provided. Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims. Each of the inventions will now be described in greater detail below, including specific embodiments, versions and examples, but the inventions are not limited to these embodiments, versions or examples, which are included to enable a person having ordinary skill in the art to make and use the inventions when the information in this patent is combined with available information and technology.

Various terms as used herein are shown below. To the extent a term used in a claim is not defined below, it should be given the broadest definition persons in the pertinent art have given that term as reflected in printed publications and issued patents. Further, unless otherwise specified, all compounds described herein may be substituted or unsubstituted and the listing of compounds includes derivatives thereof.

The term “activity” refers to the weight of product produced per weight of the catalyst used in a process per hour of reaction at a standard set of conditions (e.g., grams product/gram catalyst/hr).

The term “heat transfer improvement” or “improved heat transfer” is measured by the cooling water temperature and the heat transfer of the process is improved when the cooling water experiences a slower (or less of a) decline in the heat transfer coefficient over time.

### Catalyst Systems

Catalyst systems useful for polymerizing olefin monomers include any catalyst system known to one skilled in the art. For example, the catalyst system may include metallocene catalyst systems, single site catalyst systems, Ziegler-Natta catalyst systems, chromium based catalyst systems or combinations thereof. A brief discussion of such catalyst systems is included below, but is in no way intended to limit the scope of the invention to such catalysts.

Ziegler-Natta catalyst systems are generally formed from the combination of a metal component (e.g., a catalyst) with one or more additional components, such as a catalyst support, a cocatalyst and/or one or more electron donors, for example.

A specific example of a Ziegler-Natta (Z-N) catalyst includes a metal component (generally represented by the formula:

MRₓ;

wherein M is a transition metal, R is a halogen, an alkoxy, or a hydrocarboxyl group and x is the valence of the transition metal. For example, x may be from 1 to 4.

The transition metal may be selected from Groups IV through VIB (e.g., titanium, chromium or vanadium), for example. R may be selected from chlorine, bromine, carbonate, ester or an alkoxy group in one embodiment. Examples of catalyst components include TiCl₄, TiBr₄, Ti(OC₂H₅)₃Cl, Ti(OC₃H₇)₂Cl₂, Ti(OC₆H₁₃)₂Cl₂, Ti(OC₂H₅)₂Br₂ and Ti(OC₁₂H₂₅)Cl₃, for example.

Those skilled in the art will recognize that a catalyst may be “activated” in some way before it is useful for promoting polymerization. As discussed further below, activation may be accomplished by contacting the catalyst with an activator “Z-N activator”, which is also referred to in some instances as a “cocatalyst.” Embodiments of such Z-N activators include organoaluminum compounds, such as trimethyl aluminum (TMA), triethyl aluminum (TEAI) and triisobutyl aluminum (TiBAI), for example.

The Ziegler-Natta catalyst system may further include one or more electron donors, such as internal electron donors and/or external electron donors, which may be used to alter the atactic form of the resulting polymer, thus decreasing the amount of xylene solubles in the polymer. The internal electron donors may include amines, amides, esters, ketones, nitriles, ethers, phosphines, diethers, succinates, phthalates or dialkoxybenzenes, for example. (See, U.S. Pat. No. 5,945,366 and U.S. Pat. No. 6,399,837, which are incorporated by reference herein.)

The external electron donors may include monofunctional or polyfunctional carboxylic acids, carboxylic anhydrides, carboxylic esters, ketones, ethers, alcohols, lactones, organophosphorus compounds and/or organosilicon compounds, for example. In one embodiment, the external donor may include diphenyldimethoxysilane (DPMS), cyclohexymethyldimethoxysilane (CMDS), diisopropyldimethoxysilane (DIDS) and/or dicyclopentyldimethoxysilane (CPDS), for example. The external donor may be the same or different from the internal electron donor used.

The components of the Ziegler-Natta catalyst system (e.g., catalyst, activator and/or electron donors) may or may not be associated with a support, either in combination with each other or separate from one another. The Z-N support materials may include a magnesium dihalide, such as magnesium dichloride or magnesium dibromide and/or silica, for example.

The Ziegler-Natta catalyst may be formed by any method known to one skilled in the art. For example, the Ziegler-Natta catalyst may be formed by contacting a transition metal halide with a metal alkyl or metal hydride. (See, U.S. Pat. No. 4,298,718, U.S. Pat. No. 4,298,718, U.S. Pat. No. 4,544,717, U.S. Pat. No. 4,767,735 and U.S. Pat. No. 4,544,717, which are incorporated by reference herein.)

In one specific embodiment, the catalyst system includes a magnesium chloride support. In one embodiment, the catalyst system includes a catalyst capable of producing a polymer having a high melting index (as measured by MI₅). For example, the melt flow index may be from about 200 dg/min. to about 1500 dg/min., or from about 400 dg/min. to about 600 dg/min. or from about 425 dg/min. to about 575 dg/min.

### Polymerization Processes

As indicated elsewhere herein, catalyst systems are used to form polyolefin compositions. Once the catalyst system is prepared, as described above and/or as known to one skilled in the art, a variety of processes may be carried out using that composition. The equipment, process conditions, reactants, additives and other materials used in polymerization processes will vary in a given process, depending on the desired composition and properties of the polymer being formed. Such processes may include solution phase, gas phase, slurry phase, bulk phase, high pressure processes or combinations thereof, for example. (See, U.S. Pat. No. 5,525,678; U.S. Pat. No. 6,420,580; U.S. Pat. No. 6,380,328; U.S. Pat. No. 6,359,072; U.S. Pat. No. 6,346,586; U.S. Pat. No. 6,340,730; U.S. Pat. No. 6,339,134; U.S. Pat. No. 6,300,436; U.S. Pat. No. 6,274,684; U.S. Pat. No. 6,271,323; U.S. Pat. No. 6,248,845; U.S. Pat. No. 6,245,868; U.S. Pat. No. 6,245,705; U.S. Pat. No. 6,242,545; U.S. Pat. No. 6,211,105; U.S. Pat. No. 6,207,606; U.S. Pat. No. 6,180,735 and U.S. Pat. No. 6,147,173, which are incorporated by reference herein.)

In certain embodiments, the processes described above generally include polymerizing one or more olefin monomers to form polymers. The olefin monomers may include C₂ to C₃₀ olefin monomers or C₂ to C₁₂ olefin monomers (e.g., ethylene, propylene, butene, pentene, methylpentene, hexene, octene and decene), for example. Other monomers may include ethylenically unsaturated monomers, C₄ to C₁₈ diolefins, conjugated or nonconjugated dienes, polyenes, vinyl monomers and cyclic olefins, for example. Non-limiting examples of other monomers may include norbornene, nobornadiene, isobutylene, isoprene, vinylbenzocyclobutane, sytrene, alkyl substituted styrene, ethylidene norbornene, dicyclopentadiene and cyclopentene, for example. The formed polymer may include homopolymers, copolymers or terpolymers, for example.

Examples of solution processes are described in U.S. Pat. No. 4,271,060, U.S. Pat. No. 5,001,205, U.S. Pat. No. 5,236,998 and U.S. Pat. No. 5,589,555, which are incorporated by reference herein.

One example of a gas phase polymerization process includes a continuous cycle system, wherein a cycling gas stream (otherwise known as a recycle stream or fluidizing medium) is heated in a reactor by heat of polymerization. The heat is removed from the cycling gas stream in another part of the cycle by a cooling system external to the reactor. The cycling gas stream containing one or more monomers may be continuously cycled through a fluidized bed in the presence of a catalyst under reactive conditions. The cycling gas stream is generally withdrawn from the fluidized bed and recycled back into the reactor. Simultaneously, polymer product may be withdrawn from the reactor and fresh monomer may be added to replace the polymerized monomer. The reactor pressure in a gas phase process may vary from about 100 psig to about 500 psig, or from about 200 psig to about 400 psig or from about 250 psig to about 350 psig, for example. The reactor temperature in a gas phase process may vary from about 30° C. to about 120° C., or from about 60° C. to about 115° C., or from about 70° C. to about 110° C. or from about 70° C. to about 95° C., for example. (See, for example, U.S. Pat. No. 4,543,399; U.S. Pat. No. 4,588,790; U.S. Pat. No. 5,028,670; U.S. Pat. No. 5,317,036; U.S. Pat. No. 5,352,749; U.S. Pat. No. 5,405,922; U.S. Pat. No. 5,436,304; U.S. Pat. No. 5,456,471; U.S. Pat. No. 5,462,999; U.S. Pat. No. 5,616,661; U.S. Pat. No. 5,627,242; U.S. Pat. No. 5,665,818; U.S. Pat. No. 5,677,375 and U.S. Pat. No. 5,668,228, which are incorporated by reference herein.)

Slurry phase processes generally include forming a suspension of solid, particulate polymer in a liquid polymerization medium, to which monomers and optionally hydrogen, along with catalyst, are added. The suspension (which may include diluents) may be intermittently or continuously removed from the reactor where the volatile components can be separated from the polymer and recycled, optionally after a distillation, to the reactor. The liquefied diluent employed in the polymerization medium may include a C₃ to C₇ alkane (e.g., hexane or isobutane), for example. The medium employed is generally liquid under the conditions of polymerization and relatively inert. A bulk phase process is similar to that of a slurry process. However, a process may be a bulk process, a slurry process or a bulk slurry process, for example.

In a specific embodiment, a slurry process and/or a bulk process may be carried out continuously in one or more loop reactors. As used herein, the term “bulk process” refers to polymerization in the absence of solvent. The catalyst, as slurry or as a dry free flowing powder, may be injected regularly to the reactor loop, which can itself be filled with circulating slurry of growing polymer particles in a diluent, for example. Optionally, hydrogen may be added to the process, such as for molecular weight control of the resultant polymer. The loop reactor may be maintained at a pressure of from about 27 bar to about 50 bar or from about 35 bar to about 45 bar and a temperature of from about 38° C. to about 121° C., for example. Reaction heat may be removed through the loop wall via any method known to one skilled in the art, such as via a double-jacketed pipe or heat exchanger, for example.

Alternatively, other types of polymerization processes may be used, such as stirred reactors in series, parallel or combinations thereof, for example. Upon removal from the reactor, the polymer may be passed to a polymer recovery system for further processing, such as addition of additives and/or extrusion, for example.

Unfortunately, polymerization processes experience reactor heat transfer loss. In some processes, such heat transfer loss is substantial enough to require termination of the reaction. Prior belief was that, in some cases, such heat transfer loss (as may be evidenced by a decrease in cooling water temperature or a loss in jacket temperature, for example) was a result of coating of the inner reactor walls. Therefore, attempts to improve heat transfer included employing anti-fouling agents. However, such attempts were met with mixed results.

However, we have discovered that altering the polymerization conditions in order to alter the morphology of the formed polymer unexpectedly has a significant effect on the heat transfer properties of the reaction zone (e.g., polymerization processes experiencing poorer heat transfer properties are improved when reaction conditions are modified specifically to increase the average particle size of the polymer).

Therefore, embodiments of the invention generally include processes for altering the formed polymer morphology to improve the heat transfer properties of polymerization processes. Such processes generally include analyzing and/or recognizing the morphology of the polymer to be formed. Such analysis may be a result of prior polymerizations or a result of the polymerization in the current process. However, it should be noted that while the polymer morphology may be changed, it may be desirable to maintain certain polymer properties within desired ranges, as described in further detail below.

The process further includes altering the slurry to reduce the heat transfer loss from the reaction zone. The slurry may be altered in a number of ways. For example, the slurry may be altered by changing the type of catalyst fed to the reactor. In such an embodiment, the type of catalyst may be changed to a catalyst that does not typically produce a high level of fines (e.g., greater than about 5%, or 7% or 10%, which as known to one skilled in the art, may depend on process conditions). As used herein, the term “fines” refers to polymer particles having a particle size that is less than about 63μ. However, certain processes may not allow for a catalyst change to alter the slurry.

In one embodiment, the catalyst system is prepolymerized to further reduce the amount of fines. The pre-polymerization may occur in any manner known by one skilled in the art. For example, the pre-polymerization reaction may include introducing an olefin monomer (e.g., the same olefin monomer used in the polymerization reaction) into a mixture of catalyst and co-catalyst. As a result, the monomer generally adheres to the surface of the catalyst, forming a coating.

Embodiments of the invention include changing process parameters, such as pressure and/or temperature such that polymer particle size and/or overall wax content is increased. Such process changes may be accomplished by decreasing the monomer and/or increasing the catalyst feed rate, for example. By decreasing the reactor pressure, we have discovered that the average polymer particle size (as measured by D₅₀) decreases. In contrast, increasing the reactor pressure increases the average particle size, while unexpectedly resulting in a benefit in heat transfer properties. Accordingly, embodiments of the invention include control of polymer particle size in the reactor via process parameters, such as pressure.

Further, increasing the reactor pressure may raise wax production in the reactor. Prior belief was that wax production increased reactor fouling and therein hampered heat transfer properties and therefore reducing wax would improve reactor operability. Embodiments of this invention include altering reaction conditions (e.g., changing catalyst, pressure, temperature) to increase wax production and thereby improve heat transfer.

One or more embodiments of the invention may include passing a slurry through at least two reaction zones (e.g., a bimodal process). As used herein, the term bimodal process refers to a polymerization process including a plurality of reaction zones (e.g., two reaction zones) that produce a polymer exhibiting a bimodal molecular weight distribution (e.g., a bimodal polymer). For example, a single composition including at least one identifiable high molecular weight distribution and polyolefins with at least one identifiable low molecular weight distribution is considered to be a “bimodal” polyolefin.

### Polymer Product

The polymers (and blends thereof) formed via the processes described herein may include, but are not limited to, linear low density polyethylene, elastomers, plastomers, high density polyethylenes, low density polyethylenes, medium density polyethylenes, polypropylene (e.g., syndiotactic, atactic and isotactic) and polypropylene copolymers, for example.

In one specific embodiment, the polymers are bimodal.

In one specific embodiment, polymers include polyethylene.

The ethylene polymers produced in the first reaction zone may have a melt index (MI₅) of from about 300 dg/min. to about 1500 dg/min., or from about 250 dg/min to about 1000 dg/min., or from about 300 dg/min. to about 750 dg/min., or from about 350 dg/min. to about 600 dg/min. or from about 425 dg/min. to about 550 dg/min., for example.

### Product Application

The polymers and blends thereof are useful in applications known to one skilled in the art, such as forming operations (e.g., film, sheet, pipe and fiber extrusion and co-extrusion as well as blow molding, injection molding and rotary molding). Films include blown or cast films formed by co-extrusion or by lamination useful as shrink film, cling film, stretch film, sealing films, oriented films, snack packaging, heavy duty bags, grocery sacks, baked and frozen food packaging, medical packaging, industrial liners, and membranes, for example, in food-contact and non-food contact application. Fibers include melt spinning, solution spinning and melt blown fiber operations for use in woven or non-woven form to make filters, diaper fabrics, medical garments and geotextiles, for example. Extruded articles include medical tubing, wire and cable coatings, geomembranes and pond liners, for example. Molded articles include single and multi-layered constructions in the form of bottles, tanks, large hollow articles, rigid food containers and toys, for example.

### EXAMPLES

As used in the examples, “TEAl” refers to triethylaluminum aluminum. As used in the examples, “TNOAl” refers to tri-n-octyl aluminum.

As used herein, “BEM” refers to 20.2 wt. % solution of butylethylmagnesium (0.12 wt. % Al).

As used herein, “EHOH” refers to 2-ethylhexanol.

As used herein, “TNBT” refers to tetra n-butyl titanate.

Unless otherwise designated herein, all testing methods are the current methods at the time of filing.

As used herein, “Catalyst 1” refers to a high throughput screening Ziegler-Natta catalyst supported on magnesium chloride.

Catalyst 2 Preparation: Catalyst 2 used in the Examples herein was prepared by slurrying 100 mmol (54.7 g) of BEM in hexane (total volume 100 ml) and stirring (250 μm) the mixture at room temperature. In addition, 216 mmol (28.18 g) of EHOH was slurried in 50 mL of hexane and the resulting solution was added dropwise to the BEM solution at room temperature over 30 minutes. The reaction mixture was then stirred at room temperature for another hour.

The preparation then included adding 100 mmol (77.5 g) of ClTi(OⁱPr)₃ (1M in hexane) to the mixture at room temperature over 30 minutes. A clear, solid free solution (reaction mixture “A”) was obtained. The reaction mixture “A” was then stirred at room temperature for another hour.

In addition, 100 mmol (34.4 g) of TNBT and 150 mL of hexane were added to a 500 mL graduated cylinder. 200 mmol (37.04 g) of TiCl₄ was then added dropwise to the TNBT mixture at room temperature over 10 minutes to form 2TiCl₄/Ti(OBu)₄. Hexane was then added to the mixture to provide a mixture volume of 300 mL. The resulting mixture was then allowed to set over 2 hours.

The preparation then included adding the 2TiCl₄/Ti(OBu)₄ dropwise to the reaction mixture “A” at room temperature over 2 hours to form reaction mixture “B”. The reaction mixture “B” was then stirred at room temperature for another hour. The reaction mixture “B” was then decanted and the resulting solids were washed three times with 200 mL of hexane. The solids were then suspended in 200 mL of hexane.

The preparation then included adding 100 mmol (19.0 g) of TiCl₄ (diluted to 50 mL in hexane) dropwise to the reaction mixture “B” at room temperature over 20 minutes to form reaction mixture “C”. The reaction mixture “C” was then stirred at room temperature for another hour. The reaction mixture “C” was then decanted and the solids were washed with 200 mL of hexane. The solids were then suspended in 200 mL of hexane.

The preparation then included adding 100 mmol (19.0 g) of TiCl₄ (diluted to 50 mL in hexane) dropwise to the reaction mixture “C” at room temperature over 20 minutes to form reaction mixture “D”. The reaction mixture “D” was then stirred at room temperature for another hour. The reaction mixture “D” was then decanted and the solids were washed three times with 200 mL of hexane. The solids were then suspended in 150 ml of hexane.

The preparation then included adding 16 mmol (7.39 g) of TEA1 (25 wt. %) to the reaction mixture “D” at room temperature over 25 minutes to form the catalyst composition. The catalyst composition was then stirred at room temperature for another hour. The catalyst composition was then decanted and dried, resulting in a yield of about 14 g.

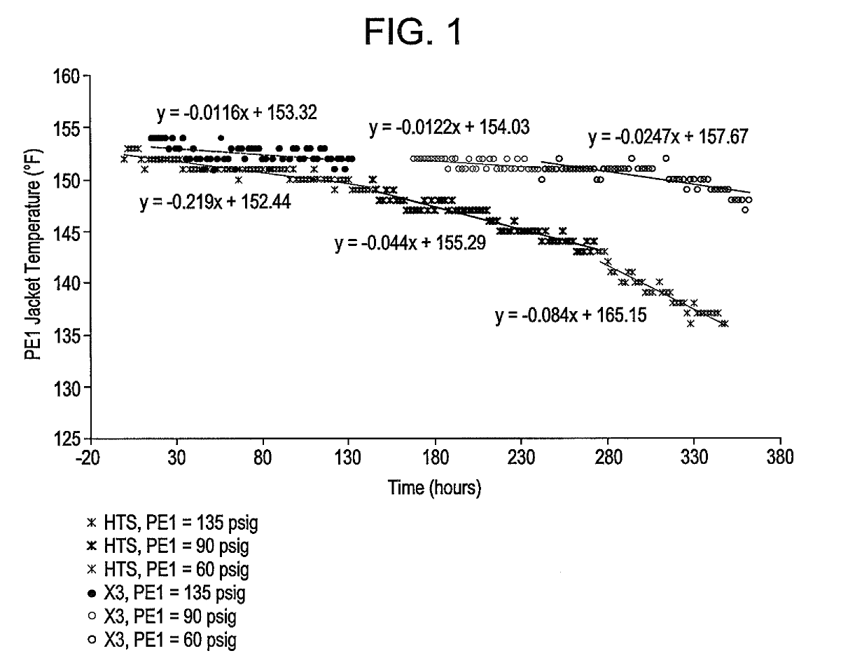

Ethylene Polymerizations: Each catalyst was mixed with hexane to form a catalyst slurry and then contacted with ethylene monomer to form polymer within a CSTR (continuously stirred tank reactor). The polymerization conditions in the first reaction zone and results of each polymerization follow in Tables 1-3 and FIG. 1.

TABLE 1

| | | | | Feed | Cat. | | | | | | | Productivity- |
|---|---|---|---|---|---|---|---|---|---|---|---|---|
| | | Co- | [Al] | Rate | Feed | T_{jacket} | T_{reactor} | P_{reactor} | H₂ | | MI₅ | Mg based |
| Run # | Catalyst | Catalyst | (mmol/L) | (pph) | Shots/hr | (F.) | (F.) | (psig) | (g/h) | H₂/C₂ | (dg/min) | (lb/lb/hr) |
| 1 | 1 | TEAL | 0.6 | 24.9 | 17 | 150.1 | 183.0 | 134.4 | 30.5 | 3.68 | 492 | 2400 |
| 2 | 1 | TEAL | 0.3 | 25.4 | 20 | 144.5 | 183.0 | 90.3 | 30.7 | 4.31 | 500 | 1300 |
| 3 | 1 | TEAL | 0.2 | 25.4 | 36 | 137.1 | 183.0 | 62.3 | 26.3 | 4.91 | 521 | 700 |
| 4 | 2 | TNOAl | 0.3 | 30.7 | 5 | 152.7 | 183.0 | 134.0 | 30.3 | 3.08 | 547 | 17200 |
| 5 | 2 | TNOAl | 0.3 | 30.9 | 22 | 151.4 | 183.0 | 90.0 | 28.0 | 3.13 | 508 | 9700 |
| 6 | 2 | TNOAl | 0.7 | 30.4 | 28 | 148.6 | 183.0 | 61.0 | 26.3 | 3.44 | 488 | 4900 |

The polymer produced in the reactor described above was then fed to a second reaction zone. The polymerization conditions in the second reaction zone and results of each polymerization follow in Table 2.

TABLE 2

| Run # | P_{reactor} (psig) | T_{reactor} (° F.) | T_{jacket} (° F.) | H₂/C₂ | MI₅ |
|---|---|---|---|---|---|
| 1 | 36.6 | 176.0 | 153.7 | 0.07 | 0.69 |
| 2 | 21.5 | 176.0 | 154.6 | 0.06 | 0.63 |
| 3 | 16.3 | 176.0 | 152.5 | 0.07 | 0.78 |
| 4 | 45.9 | 176.0 | 154.6 | 0.06 | 0.61 |
| 5 | 28.8 | 176.0 | 153.9 | 0.05 | 0.63 |
| 6 | 18.8 | 176.0 | 153.5 | 0.05 | 0.67 |

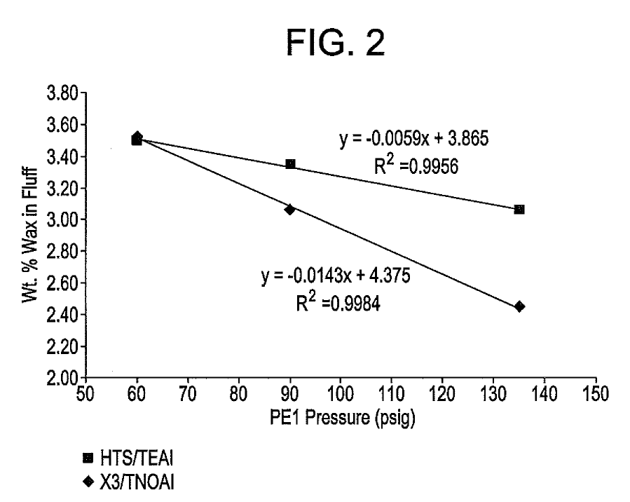

The polymer produced in the first reaction zone was then analyzed for particle size and percentage of fines. The results follow in Table 3 below and FIG. 2.

TABLE 3

| | Polymer wax | ML wax | Total wax | | |
|---|---|---|---|---|---|
| Run # | (pph) | (pph) | (pph) | D₅₀ (μ) | Fines (wt. %) |
| 1 | 1.19 | 0.71 | 1.90 | 106 | 9.8 |
| 2 | 1.47 | 0.81 | 2.28 | 94 | 19.1 |
| 3 | 1.68 | 0.50 | 2.18 | 78 | 31.2 |
| 4 | 1.48 | 0.98 | 2.46 | 128 | 3.1 |
| 5 | 1.61 | 0.80 | 2.41 | 122 | 4.0 |
| 6 | 1.66 | 0.46 | 2.12 | 100 | 12.5 |

It was observed that while the catalyst system provided reliable reactor control, higher hydrogen to ethylene ratios were necessary as pressures decreased to maintain melt flow targets. However, it was observed that as pressure was increased (by decreasing catalyst feed rate), the heat transfer improved (as evidenced by the jacket temperature). Further, it was observed that the polymer particle size decreased with decreasing pressure.

While the foregoing is directed to embodiments of the present invention, other and further embodiments of the invention may be devised without departing from the basic scope thereof and the scope thereof is determined by the claims that follow.

What is claimed is:

1. A method for improving heat transfer in olefin polymerization processes comprising:
contacting olefin monomer with a catalyst system within a reaction zone to form polymer particles comprising a first average particle size; and
altering the reaction zone to improve heat transfer and form polymer particles having a second average particle size, wherein the second average particle size is larger than the first average particle size and the second particle size results in improved heat transfer over the first particle size.

2. The method of claim 1, wherein the olefin monomer comprises ethylene.

3. The method of claim 1, wherein the altering the reaction zone results in increased wax production.

4. The method of claim 1, wherein the reaction zone is altered by increasing pressure of the reaction zone, increasing productivity of the reaction zone or combinations thereof.

5. The method of claim 4, wherein the pressure is increased and the first average particle size is increased by from about 5% to about 50% to form the second average particle size.

6. The method of claim 1, wherein the catalyst system comprises a Ziegler-Natta catalyst supported on a magnesium chloride support.

7. The method of claim 1, wherein the reaction zone comprises two reaction zone.

8. The method of claim 2, wherein the polyethylene has a bimodal molecular weight distribution.

9. The method of claim 3, wherein the wax production is increased by at least 0.05 pph.
